(19) United States
(12) Patent Application Publication
(10) Pub. No.: US 2016/0029272 A1
(43) Pub. Date: Jan. 28, 2016

(54) METHOD OF PERFORMING CELL SELECTION PROCEDURE IN WIRELESS COMMUNICATION SYSTEM

(71) Applicant: ACER INCORPORATED, New Taipei City (TW)

(72) Inventor: Shiang-Rung Ye, New Taipei City (TW)

(21) Appl. No.: 14/714,351

(22) Filed: May 18, 2015

Related U.S. Application Data
(60) Provisional application No. 62/028,792, filed on Jul. 24, 2014.

(30) Foreign Application Priority Data
Dec. 18, 2014 (TW) 103144371

(51) Int. Cl. H04W 36/08; H04W 36/14

(52) U.S. Cl. CPC H04W 36/08; H04W 36/14

(57) ABSTRACT

If a serving cell which the user equipment is currently camping on is barred from cell selection/reselection by the network, the user equipment is configured to search a suitable cell and/or an acceptable cell. Therefore, the user equipment can camp on another suitable cell or another acceptable cell more easily, thereby improving communication quality.

### CROSS REFERENCE TO RELATED APPLICATIONS

This application claims the benefit of U.S. provisional application No. 62/028,792 filed on 2014 Jul. 24.

### BACKGROUND OF THE INVENTION

1. Field of the Invention

The present invention is related to a method of performing cell selection procedure in a wireless communication system, and more particularly, to a method of performing cell selection procedure in a wireless communication system when a serving cell becomes barred.

2. Description of the Prior Art

The 3rd Generation Partnership Project (3GPP) has developed various wireless communication networks. A universal mobile telecommunications system (UMTS) or a global system for mobile communications edge radio access network (GERAN)is a 3^{rd} generation (3G) network which adopts a wideband code division multiple access (WCDMA) technology capable of providing high frequency spectrum utilization, universal coverage, and high-speed/quality multimedia data transmission. In the UMTS network, a radio access network known as a universal terrestrial radio access network (UTRAN) includes multiple cells, commonly known as Node-Bs (NBs), for communicating with multiple user equipment (UE). A long-term evolution (LTE) system is a 4^{th} generation (4G) network which includes a new radio interface and radio network architecture capable of providing a high data rate, low latency, packet optimization, and improved system capacity and coverage. In the LTE network, a radio access network known as an evolved UTRAN (E-UTRAN) includes multiple evolved NBs (eNBs) for communicating with multiple UEs and a core network which includes a mobility management entity (MME), a serving gateway and other devices for NAS (Non Access Stratum) control.

According to 3GPP specifications, after selecting a public land mobile network identity (PLMN), the UE may perform a cell selection procedure and a cell reselection procedure in order to use related network services. The cell selection procedure allows the UE to quickly camp on a serving cell, thereby receiving system information from the PLMN, establishing radio resource control (RRC) links, accessing network via control channels, and receiving/replying paging messages. The cell reselection procedure allows the UE to camp on another target cell having better signal quality than the current serving cell.

According to related 3GPP specifications (such as TS 36.304), the cells in a wireless communication system may be categorized as suitable cells, acceptable cells, barred cells or reserved cells according to service limitations. The UE may acquire the types of the cells from the status information of a system information block 3 (SIB3) or a system information block 4 (SIB4). According to related 3GPP specifications (such as TS 36.304), the UE is not allowed to camp on a barred cell or on a reserved cell. Therefore, the cell selection procedure and the cell reselection procedure can only be performed on suitable cells or acceptable cells. However, although a serving cell selected by a specific UE during a previous cell selection procedure was a suitable cell or an acceptable cell, the network may somehow set the serving cell as a barred cell or a reserved cell when the UE is currently camping on the serving cell. After that, all other UEs are forbidden to camp on the barred serving cell of the specific UE. When a serving cell of a UE changes its status from a suitable cell or an acceptable cell to a barred cell or a reserved cell, the corresponding operation of the UE has not be addressed in existing 3GPP specification and the UE may not be able to camp on another suitable cell or acceptable cell target cell by performing the cell selection procedure. Therefore, there is a need for a method of performing cell selection procedure in a wireless communication system when a serving cell becomes barred.

### SUMMARY OF THE INVENTION

The present invention provides a method of performing a cell selection procedure in a wireless communication system which includes a user equipment and a plurality of cells. The method includes the user equipment camping on a specific cell among the plurality of cells; the user equipment evaluating if the plurality of cells includes a suitable cell when camping on the specific cell if it is determined that the specific cell is allowed to be selected in the cell selection procedure or in a cell reselection procedure; and the user equipment camping on the suitable cell if the plurality of cells includes the suitable cell.

The present invention also provides method of performing a cell selection procedure in a wireless communication system which includes a user equipment and a plurality of cells. The method includes the user equipment camping on a specific cell among the plurality of cells; the user equipment evaluating if the plurality of cells includes an acceptable cell when camping on the specific cell if it is determined that the specific cell is allowed to be selected in the cell selection procedure or in a cell reselection procedure; and the user equipment camping on the acceptable cell if the plurality of cells includes the acceptable cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of performing cell selection procedure in a wireless communication system according to an embodiment of the present invention.

FIG. 2 is a flowchart illustrating a method of performing cell selection procedure in a wireless communication system according to another embodiment of the present invention.

FIG. 3 is a state diagram illustrating a method of performing cell selection procedure in a wireless communication system according to an embodiment of the present invention.

FIG. 4 is a state diagram illustrating a method of performing cell selection procedure in a wireless communication system according to another embodiment of the present invention.

### DETAILED DESCRIPTION

The present method of performing cell selection procedure may be applied to a wireless communication system which includes a UE and a plurality of cells. Each cell may be an NB of a UTRAN, an e-NB of a EUTRAN, or a base station of another type of network. The UE may include any device with telecommunication capabilities, such as mobile phones, personal digital assistants, handheld computers, tablet computers, nettop computers, or laptop computers. However, the types of the cells and the UE do not limit the scope of the present invention.

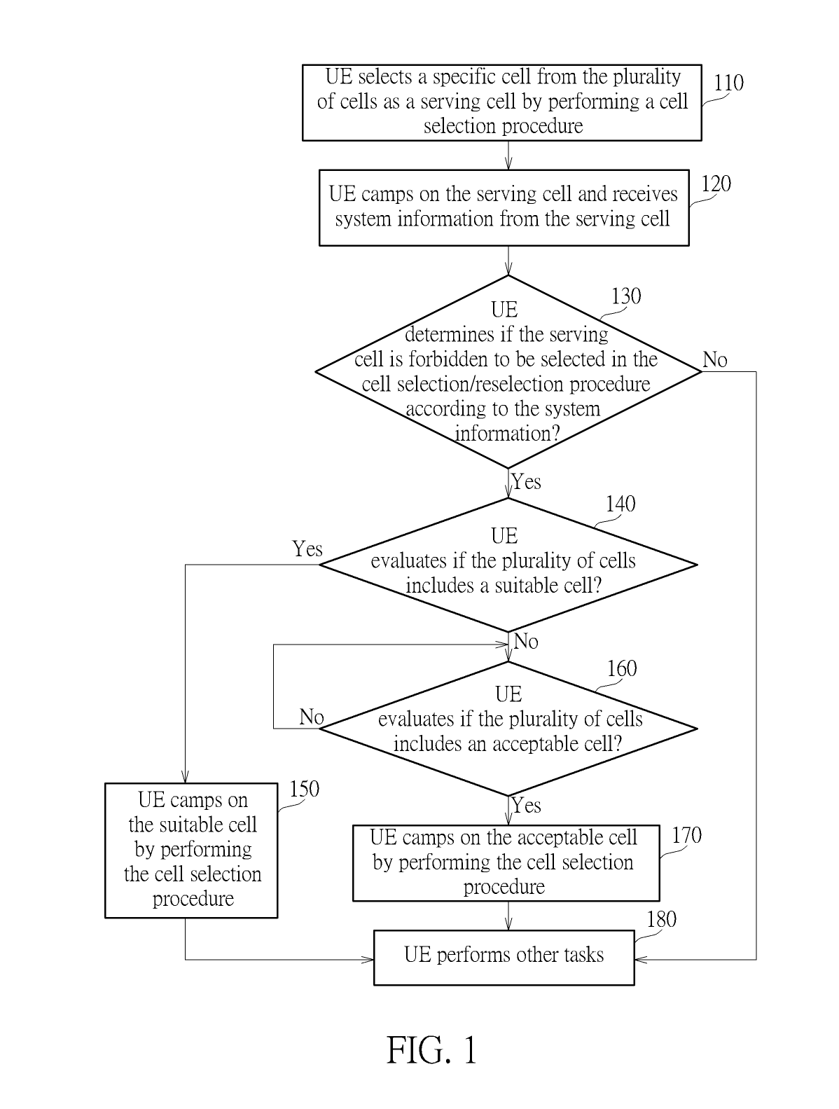

FIG. 1 is a flowchart illustrating a method of performing cell selection procedure in a wireless communication system according to an embodiment of the present invention. The method in FIG. 1 includes the following steps:

Step 110: the UE selects a specific cell from the plurality of cells as a serving cell by performing a cell selection procedure; execute step 120.

Step 120: the UE camps on the serving cell and receives system information from the serving cell; execute step 130.

Step 130: the UE determines if the serving cell is forbidden to be selected in the cell selection procedure or in the cell reselection procedure according to the system information; if yes, execute step 140; if no, execute step 180.

Step 140: the UE evaluates if the plurality of cells includes a suitable cell; if yes, execute step 150; if no, execute step 160.

Step 150: the UE camps on the suitable cell by performing the cell selection procedure; execute step 180.

Step 160: the UE evaluates if the plurality of cells includes an acceptable cell; if yes, execute step 170; if no, execute step 160.

Step 170: the UE camps on the acceptable cell by performing the cell selection procedure; execute step 180.

Step 180: the UE performs other tasks.

According to related 3GPP specifications (such as TS 36.304), the cell selection procedure includes two stages: target cell decision and serving cell decision. During the first stage of target cell decision, the UE may select the target cell according its PLMN identification list, stored cell information or the list of scanned neighboring cells. If all scanned neighboring cells are not included in the UE's PLMN identification list or no smart card is inserted, the UE is configured to select the target cell based on signal strength. After selecting the target cell, the UE may start to receive the system information from the target cell and process the system information. The system information may include parameters (Qᵣₓₗₑᵥₘₑₐₛ, Q_{qualmeas}, Qᵣₓₗₑᵥₘᵢₙ, Q_{qualmin}, Q_{rxlevminoffset}, Q_{qualminoffset}, P_{compensation}) or threshold values (Thresh_{Serving, LowQ}, Thresh_{Serving, LowP}, Thresh_{X, LowQ}, Thresh_{X, LowQ}). Based on these parameters and threshold values, the UE may calculate the parameters of Srxlev and Squal, and acquire corresponding cell selection/reselection criteria. Srxlev represents a cell selection RX level value, and Squal represents a cell selection quality value. Qᵣₓₗₑᵥₘₑₐₛ represents a measured cell RX level value or a reference signal receiving power (RSRP). Q_{qualmeas} represents a measured cell quality value or a reference signal receiving quality (RSRQ). Qᵣₓₗₑᵥₘᵢₙ represents a minimum required RX level in the cell. Q_{qualmin} represents a minimum required quality level in the cell. Q_{rxlevminoffset} represents an offset taken into account in the Srxlev evaluation as a result of a periodic search for a higher priority PLMN. Q_{qualminoffset} represents an offset taken into account in the Squal evaluation as a result of a periodic search for a higher priority PLMN. P_{compensation} represents the larger one among (P_{EMAX}-P_{PowerClass}) and 0, wherein P_{EMAX} represents the maximum transmission power of the UE and P_{PowerClass} represents the maximum radio frequency (RF)output power of the UE. Thresh_{Serving, LowQ} and Thresh_{Serving, LowP} represent low threshold values required for evaluating reselection of the serving frequency. Thresh_{X, LowQ} and Thresh_{X, LowP} represent threshold values required for reselecting low-priority frequency.

The decibel (dB) is the unit of Srxlev and Squal which are represented by the following equations:

Srxlev=Qᵣₓₗₑᵥₘₑₐₛ−(Qᵣₓₗₑᵥₘᵢₙ+Q_{rxlevminoffset})−P_{compensation} (1)

Squal=Q_{qualmeas}−(Q_{qualmin}+Q_{qualminoffset}) (2)

During the second stage of serving cell decision, the UE may determine if the target cell is a suitable cell based on the cell selection criteria which are included in the system information provided by the target cell. The cell selection criteria include judging conditions associated with signal receiving threshold (such as Srxlev and/or Squal) and status information indicated in the system information. The following equation (3) represents a cell selection criterion S1 used for frequency division duplex (FDD) structure. The following equation (4) represents a cell selection criterion S2 used for time division duplex (TDD) structure.

S1: Srxlev>0 and Squal>0 (3)

S2: Srxlev>0 (4)

For illustrative purpose, it is assumed that the specific cell is selected in the first stage, the signal strength of the specific cell is determined to be larger than a signal receiving threshold (such as when the cell selection criterion S1 or S2 is satisfied) in the second stage, and the specific cell is allowed to be selected in the cell selection procedure or in the cell reselection procedure according to the status information. Under such circumstance, the UE may select the specific cell as the serving cell in step 110.

In step 120, the UE may camp on the serving cell and receives system information from the serving cell and continuously receive cell reselection criteria, frequency list and status information from the serving cell, thereby performing the evaluation of the cell selection procedure accordingly.

As previously illustrated, although the UE is allowed to select the specific cell as the serving cell in step 110, the network may somehow change the status information of the specific cell while the UE is camping on the specific cell. For example, the status information indicated in SIB3 or SIB4 broadcast by the specific cell includes information elements (IE) of “cell barred”, “cell reserved for operator use” and “cell reservation on extension”. The IE type of “cell barred” may be set in a “barred” state or a “ not barred” state. The IE type of “cell reserved for operator use” and “cell reservation on extension” may be set in a “reserved” state or in a “not reserved” state. If the network allows the specific cell to provide normal service, the above-mentioned IEs may be set in the “not barred” state or in the “not reserved” state; if the network does not want any UE to camp on the specific cell, the above-mentioned IEs may be set in the “barred” state or in the “reserved” state.

If the UE determines that the serving cell is not forbidden to be selected in the cell selection procedure or in the cell reselection procedure according to the system information in step 130, step 180 is then executed so that the UE may perform other tasks, such as performing a cell selection evaluation or a cell reselection evaluation defined in related 3GPP specifications. If the UE determines that the serving cell is forbidden to be selected in the cell selection procedure or in the cell reselection procedure according to the system information in step 130, step 140 is then executed.

As previously illustrated, the cells in a wireless communication system may be categorized as suitable cells, acceptable cells, barred cells or reserved cells according to service limitations. When camping on a suitable cell, a UE inserted with a smartcard may receive normal services. When camping on an acceptable cell, a UE inserted with a smartcard may only receive restricted services. It is not allowed to camp on a barred cell or a reserved cell. In step 140, the UE may evaluate if the plurality of cells includes a suitable cell.

According to 3GPP specifications, the UE may use two types of cell selection evaluation: initial cell selection evaluation or stored information cell selection evaluation. The initial cell selection evaluation requires no prior knowledge of which RF channels are UTRA carriers. The UE may scan all RF channels in the UTRA bands according to its capabilities to find a suitable cell. On each carrier, the UE only search for the strongest cell. Once a suitable cell is found in the initial cell selection evaluation, this suitable cell shall be selected. On the other hand, the stored information cell selection evaluation requires stored information of carrier frequencies and optionally also information on cell parameters from previously received measurement control information elements. Once a suitable cell is found in the stored information cell selection evaluation, this suitable cell shall be selected; if no suitable cell is found in the stored information cell selection evaluation, the initial cell selection evaluation may be started.

In an embodiment, the UE may evaluate if the plurality of cells includes a suitable cell by performing an initial cell selection evaluation or a stored information cell selection evaluation in step 140. In another embodiment, the UE may evaluate if the plurality of cells includes a suitable cell by sequentially performing a stored information cell selection evaluation and an initial cell selection evaluation in step 140.

If the suitable cell can be found in step 140, the UE may camp on the suitable cell by performing the cell selection procedure in step 150. Step 180 may then be executed so that the UE may perform other tasks, such as performing a cell selection evaluation or a cell reselection evaluation defined in related 3GPP specifications.

If no suitable cell can be found in step 140, the UE may evaluate if the plurality of cells includes an acceptable cell in step 160. In an embodiment, an initial cell selection evaluation or a stored information cell selection evaluation may be used for searching the acceptable cell in step 160

If the acceptable cell can be found in step 160, the UE may camp on the acceptable cell by performing the cell selection procedure in step 170. Step 180 may then be executed so that the UE may perform other tasks, such as performing a cell selection evaluation or a cell reselection evaluation defined in related 3GPP specifications.

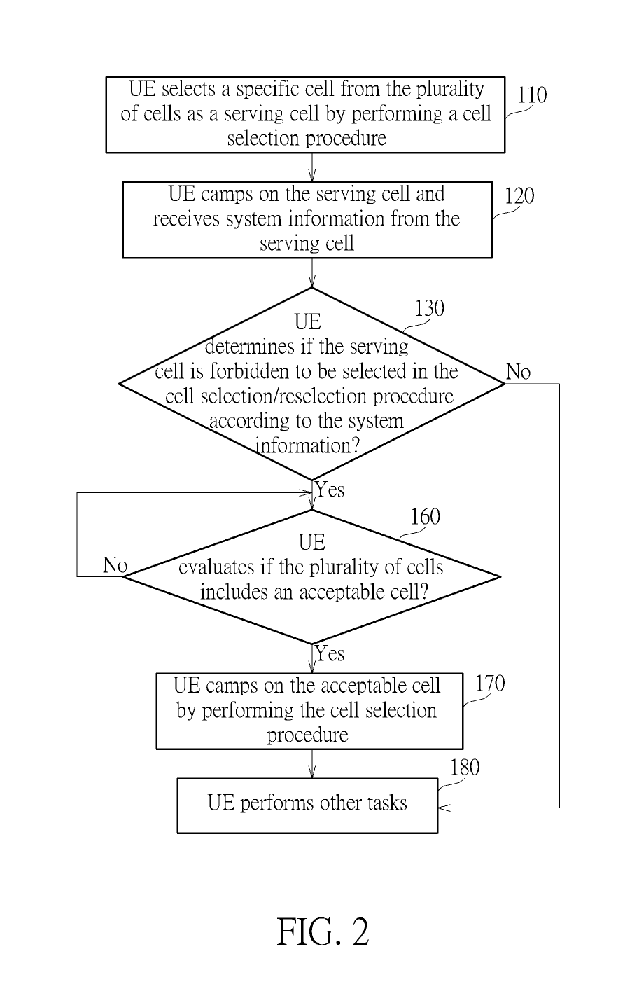

FIG. 2 is a flowchart illustrating a method of performing cell selection procedure in a wireless communication system according to another embodiment of the present invention. The method in FIG. 2 includes the following steps:

Step 110: the UE selects a specific cell from the plurality of cells as a serving cell by performing a cell selection procedure; execute step 120.

Step 120: the UE camps on the serving cell and receives system information from the serving cell; execute step 130.

Step 130: the UE determines if the serving cell is forbidden to be selected in the cell selection procedure or in the cell reselection procedure according to the system information; if yes, execute step 160; if no, execute step 180.

Step 160: the UE evaluates if the plurality of cells includes an acceptable cell; if yes, execute step 170; if no, execute step 160.

Step 170: the UE camps on the acceptable cell by performing the cell selection procedure; execute step 180.

Step 180: the UE performs other tasks.

The embodiment illustrated in FIG. 2 is similar to the embodiment illustrated in FIG. 1, but is different in the UE behavior after determining that the serving cell is forbidden to be selected in the cell selection procedure or in the cell reselection procedure in step 130. In FIG. 1, an attempt is first made to find a suitable cell before attempting to find an acceptable cell (when no suitable cell can be found). In FIG. 2, the UE only attempts to find an acceptable cell.

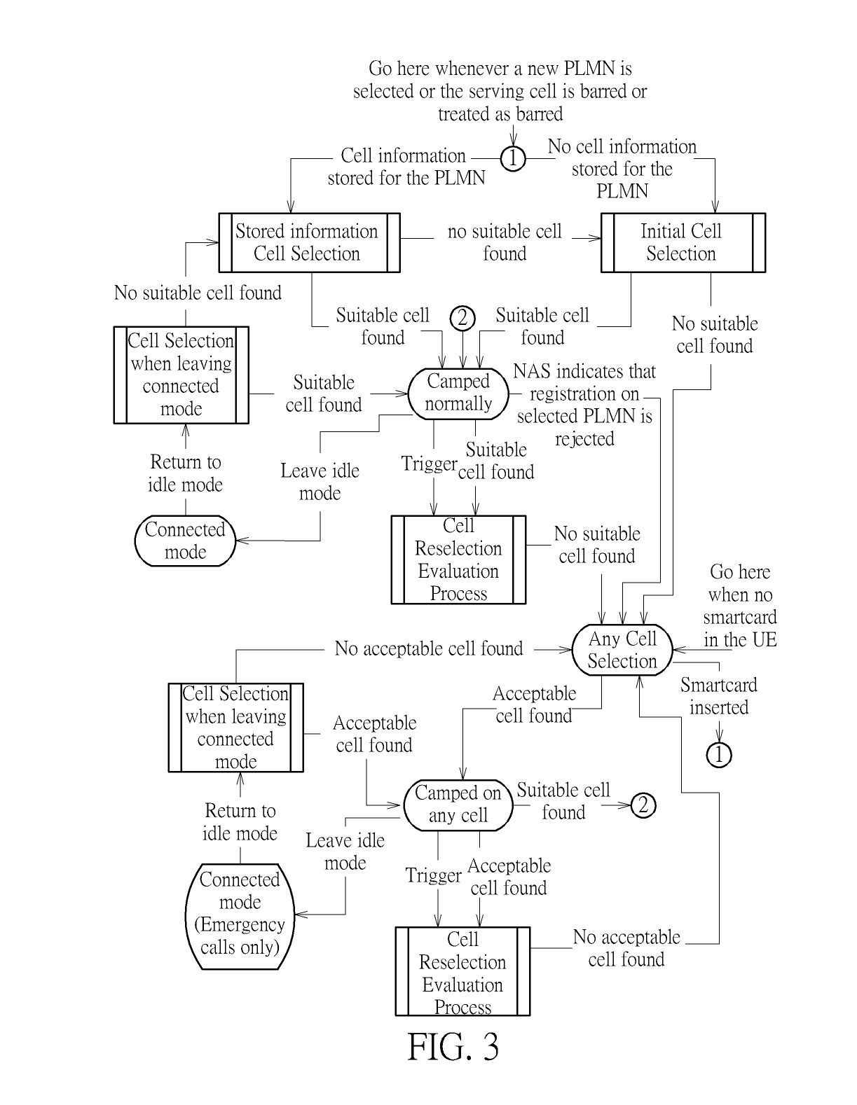

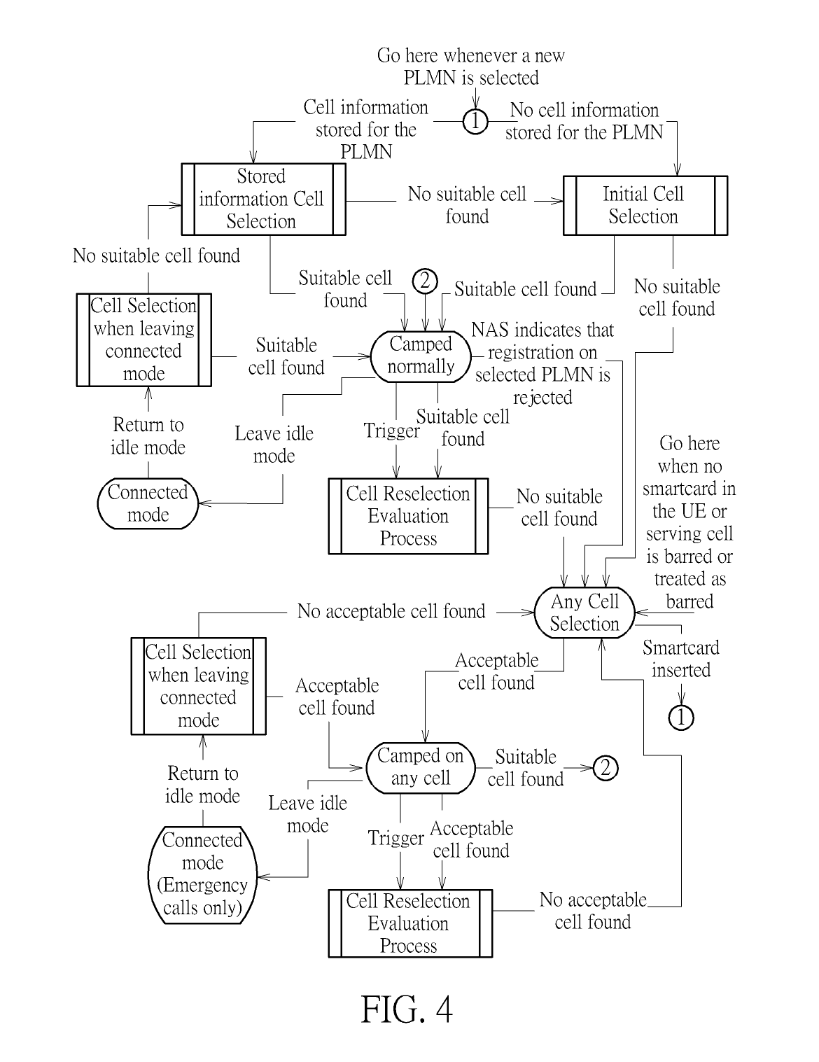

FIGS. 3 and 4 are state diagrams illustrating a method of performing cell selection procedure in a wireless communication system according to another embodiment of the present invention. The state diagram depicted in FIG. 3 corresponds to the method depicted in FIG. 1, wherein the UE enters a “cell selection evaluation state” (either initial cell selection or stored information cell selection) whenever a new PLMN is selected or the serving cell is barred or treated as barred. The state diagram depicted in FIG. 4 corresponds to the method depicted in FIG. 2, wherein the UE enters a “cell selection evaluation state” (any cell selection) when no smartcard is inserted or whenever the serving cell is barred or treated as barred.

After a UE camps on a serving cell, the network may somehow set the serving cell as a barred cell or a reserved cell when the UE is currently camping on the serving cell. In the cell selection method according to the present invention, the UE may attempt to find a suitable cell or an acceptable cell after the current serving becomes barred or treated as barred. Therefore, the present invention can enhance the chance for the UE currently camping on a barred serving cell to handover to another suitable cell or acceptable cell, thereby improving communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing a cell selection procedure in a wireless communication system which includes a user equipment and a plurality of cells, the method comprising:
the user equipment camping on a specific cell among the plurality of cells;
the user equipment evaluating if the plurality of cells includes a suitable cell when camping on the specific cell if it is determined that the specific cell is forbidden to be selected in the cell selection procedure or in a cell reselection procedure; and
the user equipment camping on the suitable cell if the plurality of cells includes the suitable cell.

2. The method of claim 1, further comprising:
the user equipment receiving system information from the specific cell when camping on the specific cell; and
the user equipment determining if the specific cell is forbidden to be selected in the cell reselection procedure or in the cell selection procedure according to status information indicated in the system information.

3. The method of claim 2, wherein:
the system information includes a “cell barred” information element, a “cell reserved for operator use” information element, and a “cell reservation on extension” information element defined in a 3rd Generation Partnership Project (3GPP) specification;
the user equipment determines that the specific cell is forbidden to be selected in the cell reselection procedure or in the cell selection procedure when one of the “cell barred” information element, the “cell reserved for operator use” information element, and the “cell reservation on extension” information element is set in a “barred” state or in a “reserved” state; and
the user equipment determines that the specific cell is allowed to be selected in the cell reselection procedure or in the cell selection procedure when all of the “cell barred” information element, the “cell reserved for operator use” information element, and the “cell reservation on extension” information element are set in a “not barred” state or in a “not reserved” state.

4. The method of claim 1, further comprising:
the user equipment evaluating if the plurality of cells includes an acceptable cell when the plurality of cells does not include the suitable cell; and
the user equipment camping on the acceptable cell if the plurality of cells includes the acceptable cell.

5. A method of performing a cell selection procedure in a wireless communication system which includes a user equipment and a plurality of cells, the method comprising:
the user equipment camping on a specific cell among the plurality of cells;
the user equipment evaluating if the plurality of cells includes an acceptable cell when camping on the specific cell if it is determined that the specific cell is forbidden to be selected in the cell selection procedure or in a cell reselection procedure; and
the user equipment camping on the acceptable cell if the plurality of cells includes the acceptable cell.

6. The method of claim 5, further comprising:
the user equipment receiving system information from the specific cell when camping on the specific cell; and
the user equipment determining if the specific cell is forbidden to be selected in the cell reselection procedure or in the cell selection procedure according to status information indicated in the system information.

7. The method of claim 6, wherein:
the system information includes a “cell barred” information element, a “cell reserved for operator use” information element, and a “cell reservation on extension” information element defined in a 3rd Generation Partnership Project (3GPP) specification;
the user equipment determines that the specific cell is forbidden to be selected in the cell reselection procedure or in the cell selection procedure when one of the “cell barred” information element, the “cell reserved for operator use” information element, and the “cell reservation on extension” information element is set in a “barred” state or in a “reserved” state; and
the user equipment determines that the specific cell is allowed to be selected in the cell reselection procedure or in the cell selection procedure when all of the “cell barred” information element, the “cell reserved for operator use” information element, and the “cell reservation on extension” information element are set in a “not barred” state or in a “not reserved” state.
